(19) United States
(12) Patent Application Publication
(10) Pub. No.: US 2019/0343319 A1
(43) Pub. Date: Nov. 14, 2019

(54) Automatic Curtain Cutting Machine

(71) Applicant: Wealth Long Enterprise Co., Ltd., Yuanlin City (TW)

(72) Inventors: Hao-Yu Hsu, Yuanlin City (TW); Yao-Tsun Wu, Yuanlin City (TW)

(21) Appl. No.: 15/975,914

(22) Filed: May 10, 2018

(51) Int. Cl. A47H 23/04; B26D 1/08; B26D 7/02; B26D 7/06

(52) U.S. Cl. CPC A47H 23/04; B26D 7/0683; B26D 7/02; B26D 1/08

(57) ABSTRACT

An automatic curtain cutting machine contains: a base, a support unit, a cutting device, a displacement device, and at least one clamp device. The base is configured to parallelly hold a curtain and to move the curtain thereon. A support unit includes multiple support sets and is configured to support the curtain. The cutting device moves on the base and includes a first space, a second space, and at least one cutter. The first space is configured to pass through the curtain and connects with the second space, and the at least one cutter is fixed outside the first space and vertically moves along a track of the curtain. The displacement device is disposed on the cutting device and moves as the cutting device moves so as to move the multiple support sets. The at least one clamp device is configured to clamp the curtain.

### BACKGROUND OF THE INVENTION

### Field of the Invention

The present invention relates to a curtain cutting machine, and more particularly to an automatic curtain cutting machine.

### Description of the Prior Art

Curtains are applied to shield and decorate windows of a building, and a window blind is one of various types of curtains and is produced in a few lengths (i.e. lengths of a first rail, a second rail, and the multiple slats are equal to a width of each curtain). Thereby, each curtain is cut by users based on using requirements so as to match with a size of a window.

A conventional curtain cutting machine contains a base and a fixed cutting device arranged on an end of the base so that the fixed cutting device cuts a curtain having two symmetrical ends. For example, one of the two symmetrical ends of the curtain is cut, then the curtain is turned 180 degrees so as to cut its other end, thus cutting the curtain complicatedly and troublesomely.

To overcome above-mentioned problem, as shown in FIG. 1, a conventional curtain cutting machine has been developed. The conventional curtain cutting machine contains an elongated base 91, a first fixed cutting device 92A and a second fixed cutting device 92B which are arranged on two ends of the base 91 respectively. The base 91 has two parallel guide rods 911 defined between the first fixed cutting device 92A and the second fixed cutting device 92B, and the two guide rods 911 have a first holder 93A and a second holder 93B which slide along the two guide rods 911 individually. The first fixed cutting device 92A has a first measurement part 94A disposed outside the first fixed cutting device 92A, the second fixed cutting device 92B has a second measurement part 94B disposed outside the second fixed cutting device 92B, and the base 91 further includes a first measuring rule 95A and a second measuring rule 95B.

In operation, the curtain is clamped by the first holder 93A and the second holder 93B so that when the curtain is moved to the first fixed cutting device 92A, the first measurement part 94A measures an end of the curtain which is cut, and the first holder 93A and the second holder 93B are fixed on the two guide rods 911 respectively so as to fix the curtain, then the first fixed cutting device 92A cuts the end of the curtain. Thereafter, the first holder 93A and the second holder 93B are released and move toward the second fixed cutting device 92B so that the second measuring rule 95B measures a desired length of the curtain, and the first holder 93A and the second holder 93B are mounted on the two guide rods 911 individually so as to fix the curtain. Then, the other end of the curtain over the desired length is cut. In contrast, the end of the curtain close to the second fixed cutting device 92B is cut, and the other end of the curtain proximate to the first fixed cutting device 92A is cut, wherein the second measuring part 94B measures the desired length of the curtain close to the second fixed cutting device 92B, and the first measuring part 95A measures the desired length of the curtain close to the first fixed cutting device 92A.

As cutting the curtain, the curtain is clamped and is actuated by the first holder 93A and the second holder 93B so as to move to one of the two fixed cutting devices (such as the first fixed cutting device 92A or the second fixed cutting device 92B) and to be measured, and the first holder 93A and the second holder 93B are locked on the two guide rods 911 respectively so as to fix the curtain and to cut the end of the curtain. Thereafter, the first holder 93A and the second holder 93B are released so as to move toward the other of the two fixed cutting devices (such as the second fixed cutting device 92B or the first fixed cutting device 92A) and to be measured, then the first holder 93A and the second holder 93B are locked on the two guide rods 911 individually so as to fix the curtain. Thereafter, the other end of the curtain is cut. However, the curtain is cut by two fixed cutting devices (i.e., the first fixed cutting device 92A and the second fixed cutting device 92B) and is clamped by the first holder 93A and the second holder 93B. Furthermore, the first holder 93A and the second holder 93B are locked and released repeatedly, thus having high fabrication cost and inconvenient operation.

The present invention has arisen to mitigate and/or obviate the afore-described disadvantages.

### SUMMARY OF THE INVENTION

The primary objective of the present invention is to provide an automatic curtain cutting machine which cuts two ends of a curtain automatically so as to avoid turning the curtain, thus cutting the curtain easily and quickly.

Another objective of the present invention is to provide an automatic curtain cutting machine which contains a cutting device moving on a base so as to cut by the two ends of the curtain, such that only the cutting device is required so as to simplify the automatic curtain cutting machine and to reduce fabrication cost.

To achieve above-mentioned objectives, an automatic curtain cutting machine provided by the present invention contains: a base, a support unit, a cutting device, a displacement device, and at least one clamp device.

The base axially extends and is configured to parallelly hold a curtain on the base, and the curtain moves on the base.

The support unit includes multiple support sets movably arranged on the base, and the support unit is configured to support the curtain.

The cutting device is mounted and moves on the base, and the cutting device includes a first space, a second space, and at least one cutter.

The first space is configured to pass through the curtain and connects with the second space so that each of the multiple support sets moves through the second space, and the at least one cutter is fixed outside the first space and vertically moves along a track of the curtain, wherein the track is a datum line so that an end of the curtain over the datum line is cut.

The displacement device is disposed on the cutting device and moves with the cutting device, and the displacement device is configured to move the multiple support sets which correspond to a moving track of the at least one cutter.

The at least one clamp device is configured to clamp the curtain so that the curtain is cut.

### BRIEF DESCRIPTION OF THE DRAWINGS

FIG. 1 is a perspective view of a conventional curtain cutting machine.

FIG. 2 is a perspective view showing the assembly of an automatic curtain cutting machine according to a preferred embodiment of the present invention.

FIG. 3 is another perspective view showing the assembly of the automatic curtain cutting machine according to the preferred embodiment of the present invention.

FIG. 4 is a perspective view showing the assembly of a part of the automatic curtain cutting machine according to the preferred embodiment of the present invention.

FIG. 5 is a perspective view showing the assembly of another part of the automatic curtain cutting machine according to the preferred embodiment of the present invention.

FIG. 6 is a side plane view showing the assembly of the automatic curtain cutting machine according to the preferred embodiment of the present invention.

FIG. 7 is a top plane view showing the assembly of a part of the automatic curtain cutting machine according to the preferred embodiment of the present invention.

FIG. 8 is a side plane view showing the operation of a part of the automatic curtain cutting machine according to the preferred embodiment of the present invention.

FIG. 9 is a side plane view showing the operation of the automatic curtain cutting machine according to the preferred embodiment of the present invention.

FIG. 10 is another side plane view showing the operation of a part of the automatic curtain cutting machine according to the preferred embodiment of the present invention.

FIG. 11 is also another side plane view showing a part of the operation of the automatic curtain cutting machine according to the preferred embodiment of the present invention.

FIG. 12 is another side plane view showing the operation of the automatic curtain cutting machine according to the preferred embodiment of the present invention.

FIG. 13 is also another side plane view showing the operation of the automatic curtain cutting machine according to the preferred embodiment of the present invention.

FIGS. 14-16 are also another side plane view showing the operation of the automatic curtain cutting machine according to the preferred embodiment of the present invention.

FIGS. 17-19 are still another side plane view showing the operation of the automatic curtain cutting machine according to the preferred embodiment of the present invention.

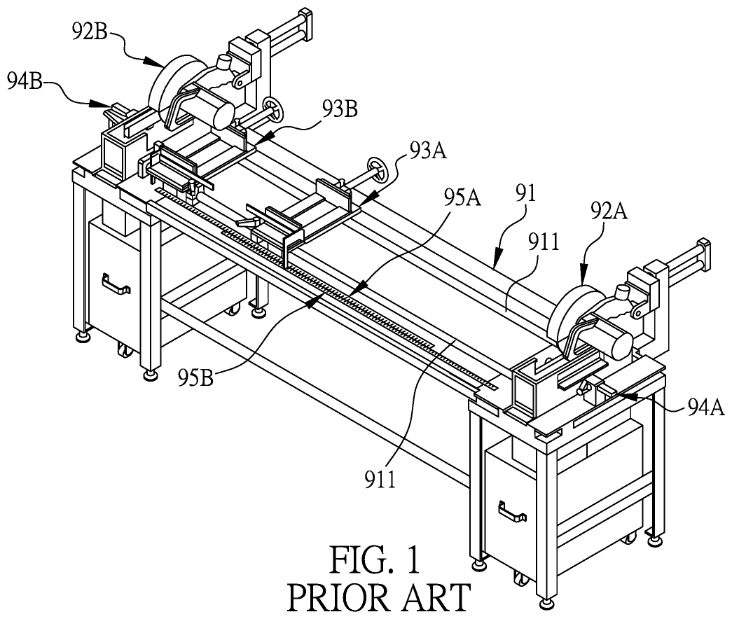

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

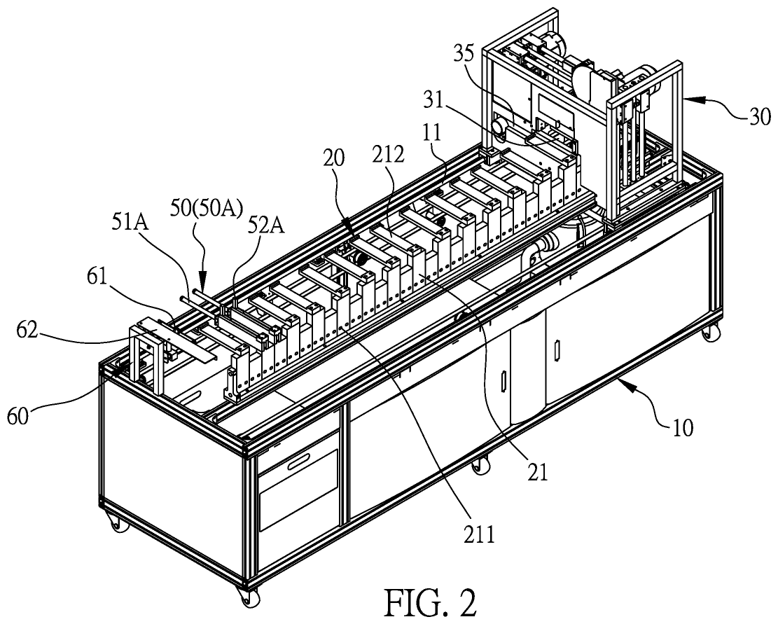

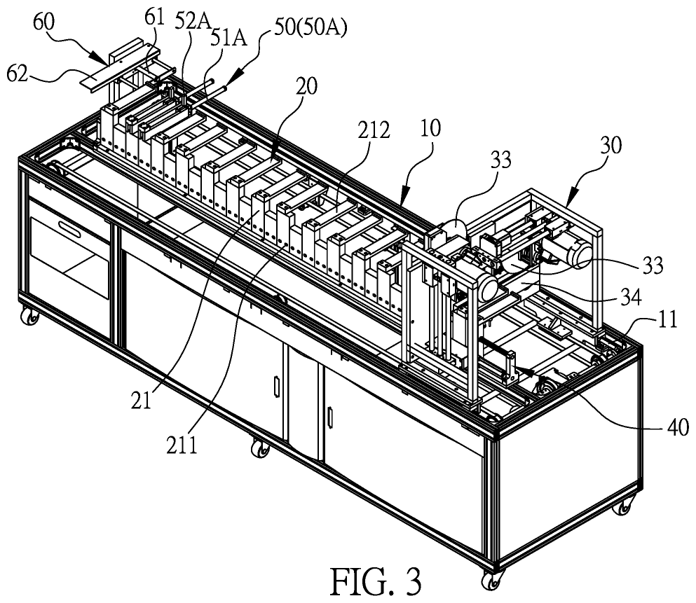

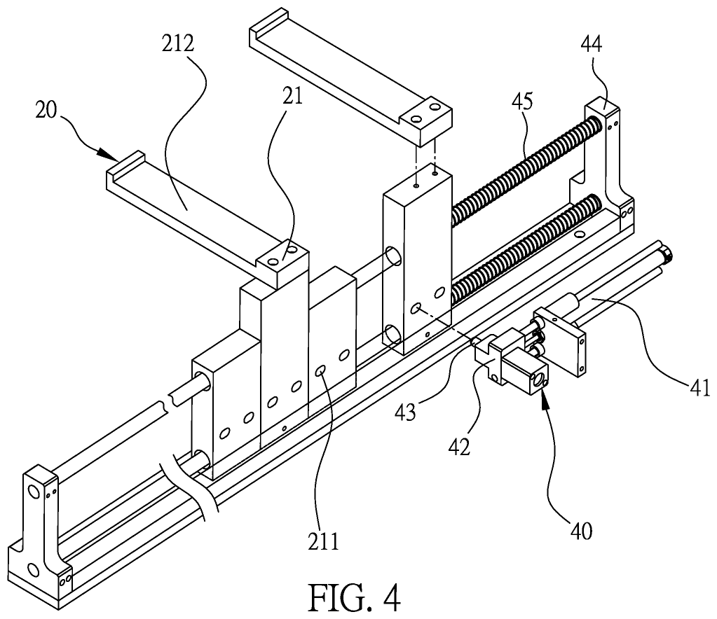

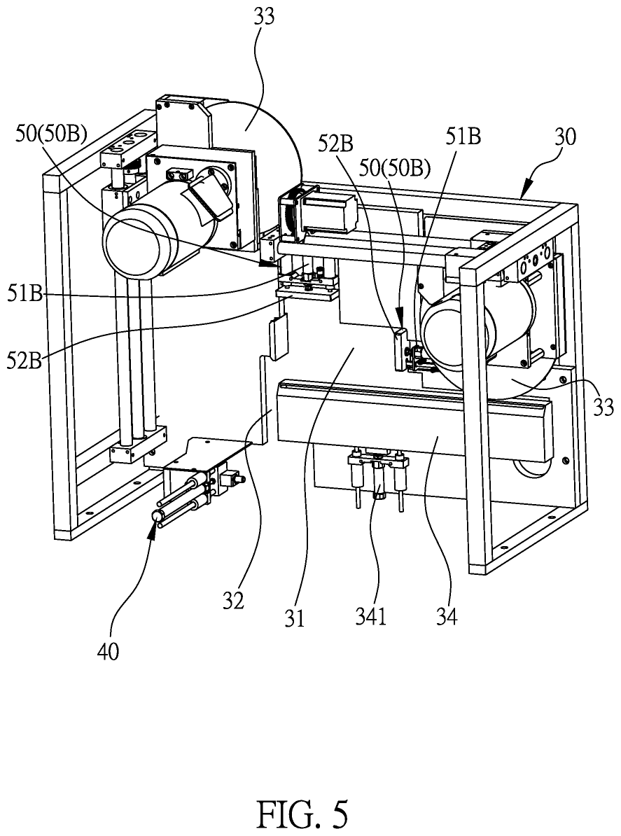

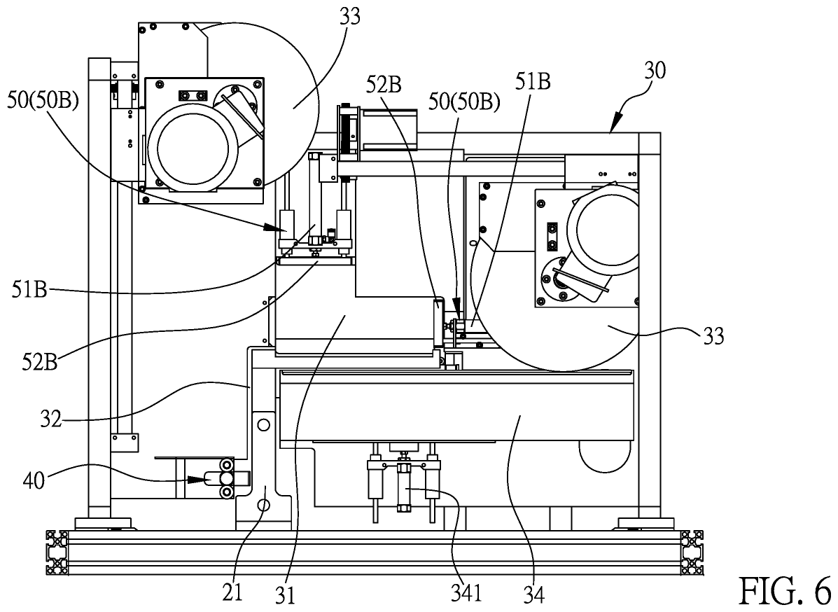

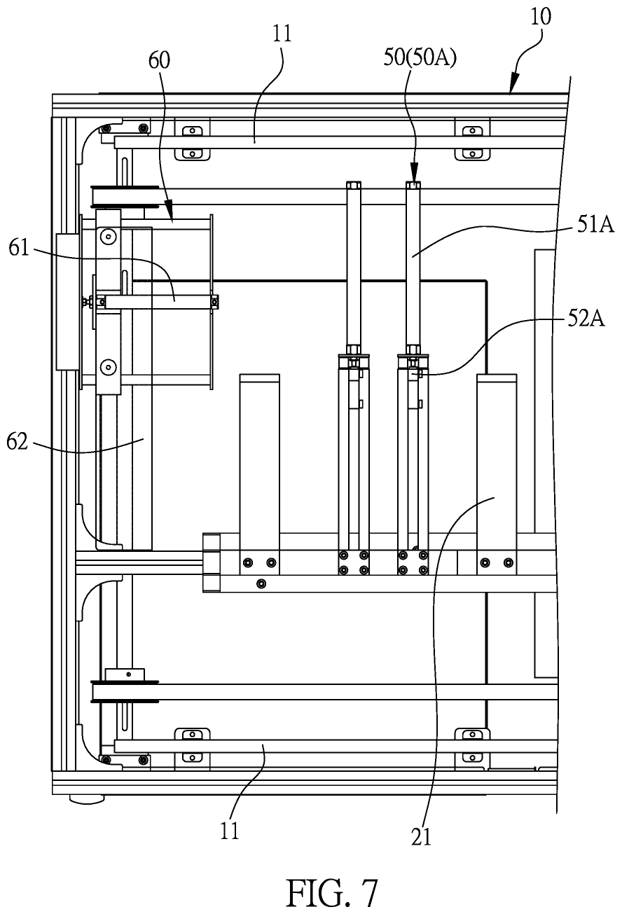

With reference to FIGS. 2-7, an automatic curtain cutting machine according to a preferred embodiment of the present invention comprises: a base 10, a support unit 20, a cutting device 30, a displacement device 40, at least one clamp device 50, and a movable positioning device 60.

The base 10 is elongated and axially extends, and the base 10 includes two slide rails 11 arranged between two ends of the base 10 respectively.

The support unit 20 includes multiple support sets 21 movably arranged on the base 10, each of the multiple support sets 21 has at least one orifice 211 defined proximate to a bottom of each support set 21, at least one part of the multiple support sets 21 is in an inverted L shape and has an accommodation groove 212 defined on a top part of the at least one support set 21.

The cutting device 30 is mounted and moves on the two slide rails 11 of the base 10, and the cutting device 30 includes a first space 31, a second space 32, two cutters 33, a holding plate 34, and a third space 35. A bottom of the first space 31 flushes with a top of each support set 21, the second space 32 is connected with the first space 31 so that each support set 21 moves through the second space 32, and the two cutters 33 are fixed beside two sides of the first space 31 and move vertically along the base 10 so as to cut a workpiece. The holding plate 34 is arranged below the first space 31 and has a first moving mechanism 341 formed on a bottom thereof so as to actuate the holding plate 34 to lift and descend, wherein when the holding plate 34 is actuated by the first moving mechanism 341 to lift, a top of the holding plate 34 flushes with the accommodation groove 212 of the at least one part support set 21.

The displacement device 40 is disposed on the cutting device 30, and the displacement device 40 moves the support sets 21 corresponding to the two cutters 33 as the cutting device 30 moves. The displacement device 40 includes a second moving mechanism 41, an actuation seat 42 driven by the second moving mechanism 41 so as to move along the base 10, a movable drive rod 43 secured on the actuation seat 42, a holder 44 configured to hold the multiple support sets 21, and two springs 45 configured to push the multiple support sets 21 to move back toward original positions respectively.

The at least one clamp device 50 includes a first clamping part 50A and at least one second clamping part 50B (in this embodiment, the at least one clamp device 50 includes a first clamping part 50A and two second clamping parts 50B), wherein the first clamping part 50A is fixed on one of the multiple support sets 21 of the support unit 20, the first clamping part 50A has two third moving mechanisms 51A and two press elements 52A driven by the two third moving mechanism 51A to vertically move along the base 10. When the cutting device 30 slides, it avoids moving through the first clamping part 50A by way of the third space 35. The two second clamping parts 50B are arranged beside the first space 31 of the cutting device 30 so as to move, when the cutting device 30 moves. Each of the two second clamping parts 50B has a fourth moving mechanism 51B and an abutting plate 52B driven by the fourth moving mechanism 51B to move close to or away from the first space 31.

The movable positioning device 60 is mounted on an end of the base 10, and the movable positioning device 60 includes a fifth moving mechanism 61 and a fixing sheet 62 actuated by the fifth moving mechanism 61 so as to move on the base 10.

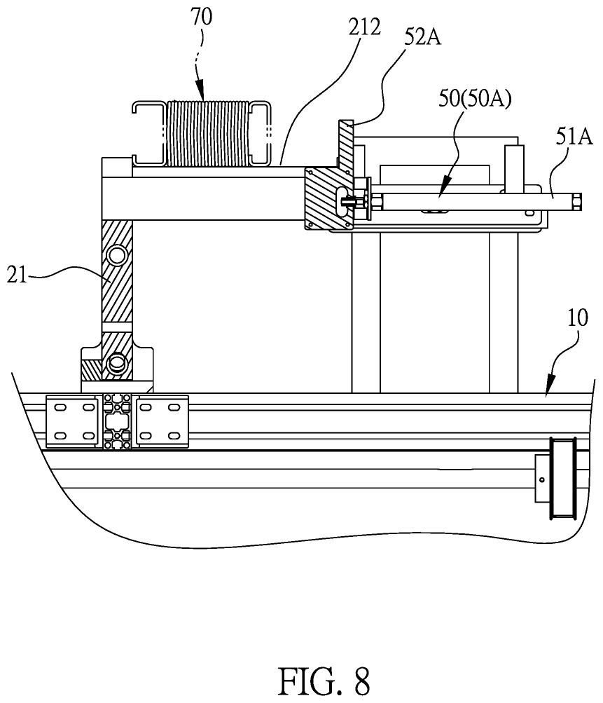

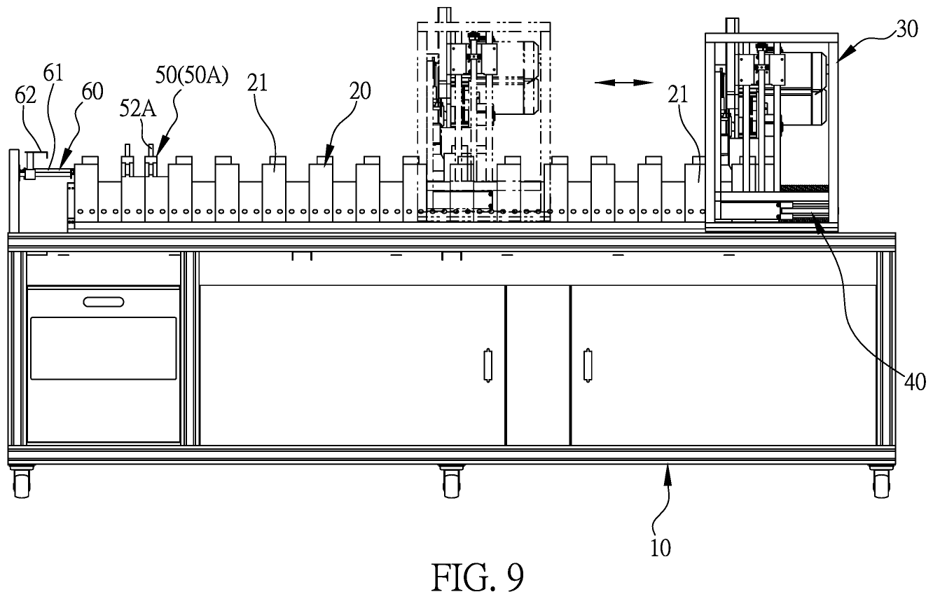

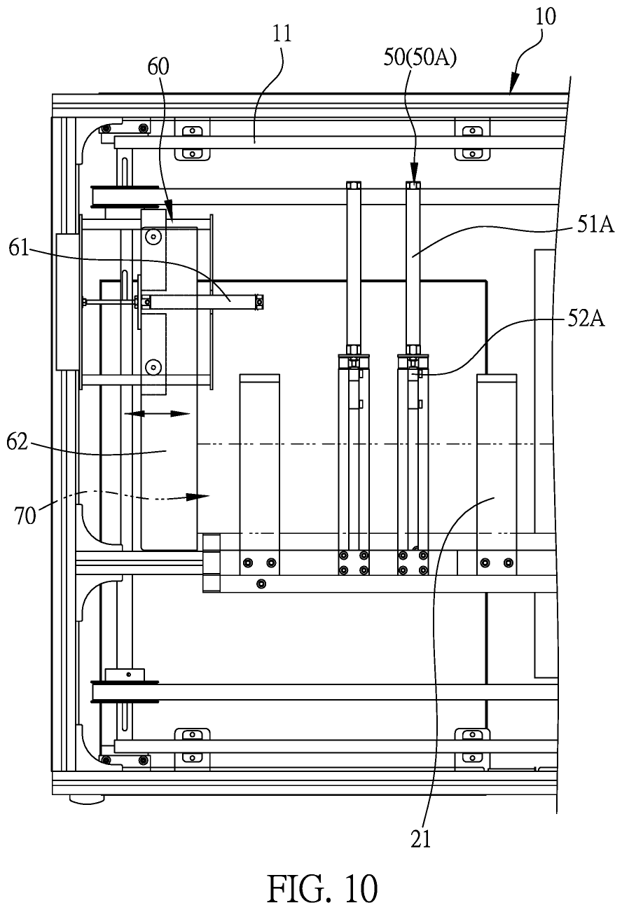

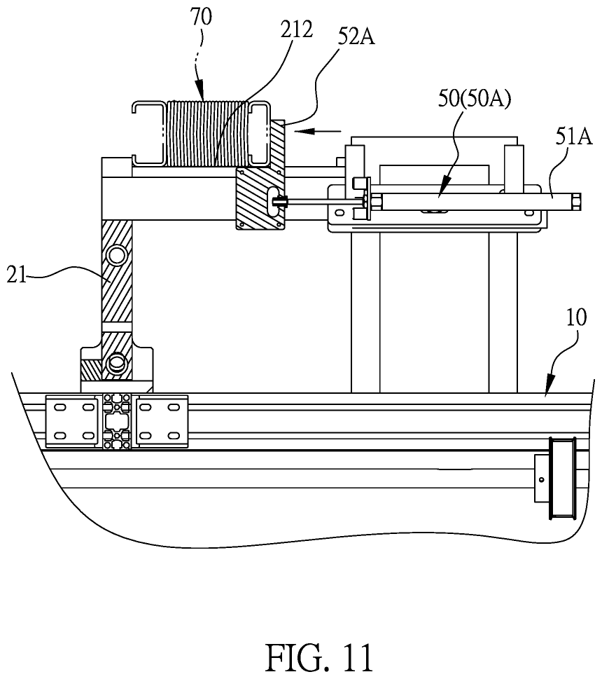

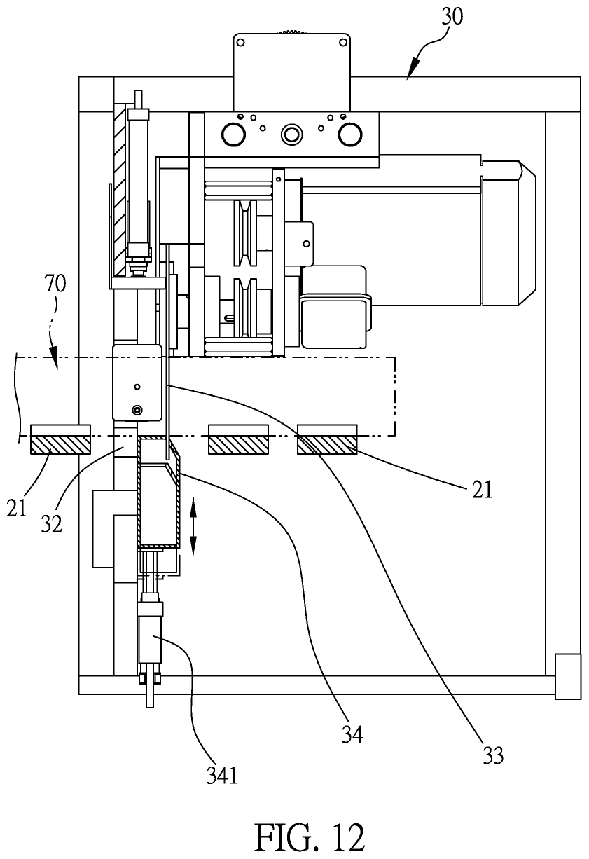

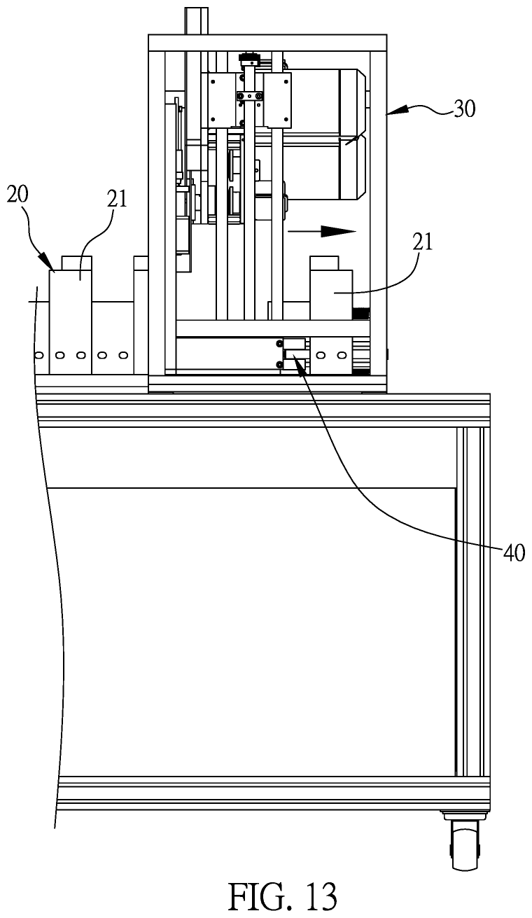

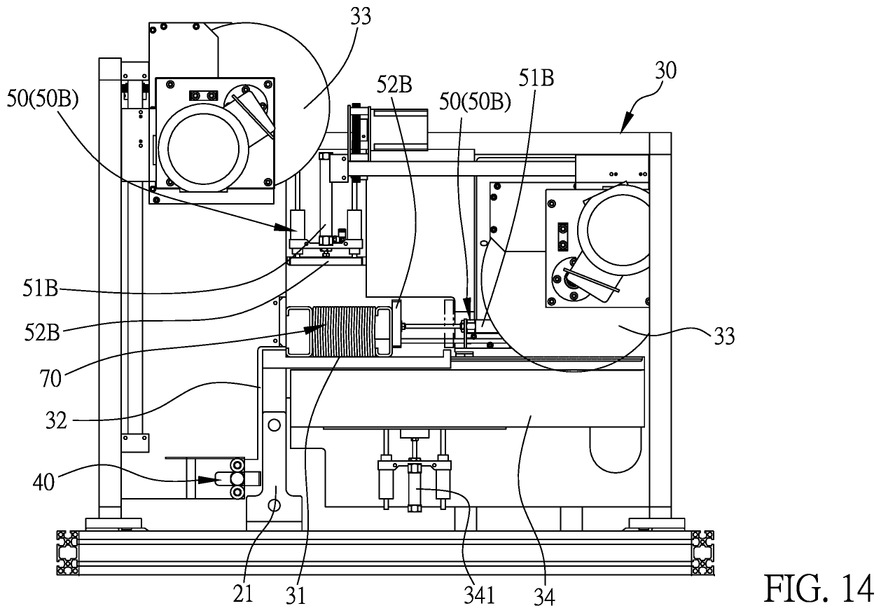

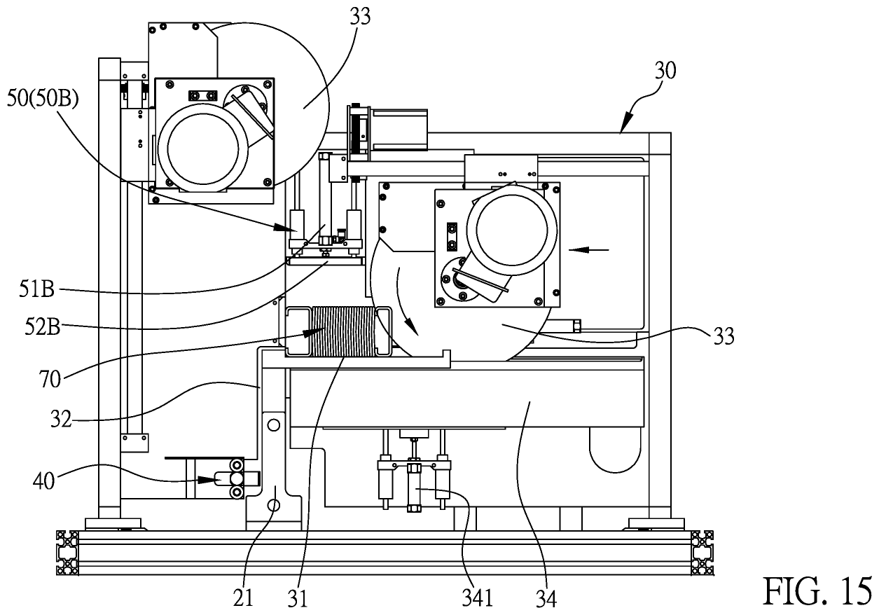

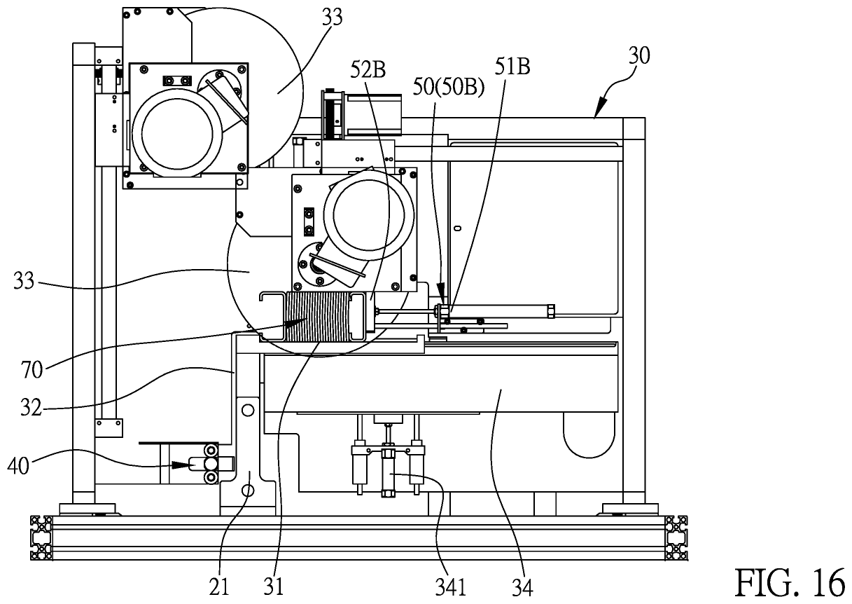

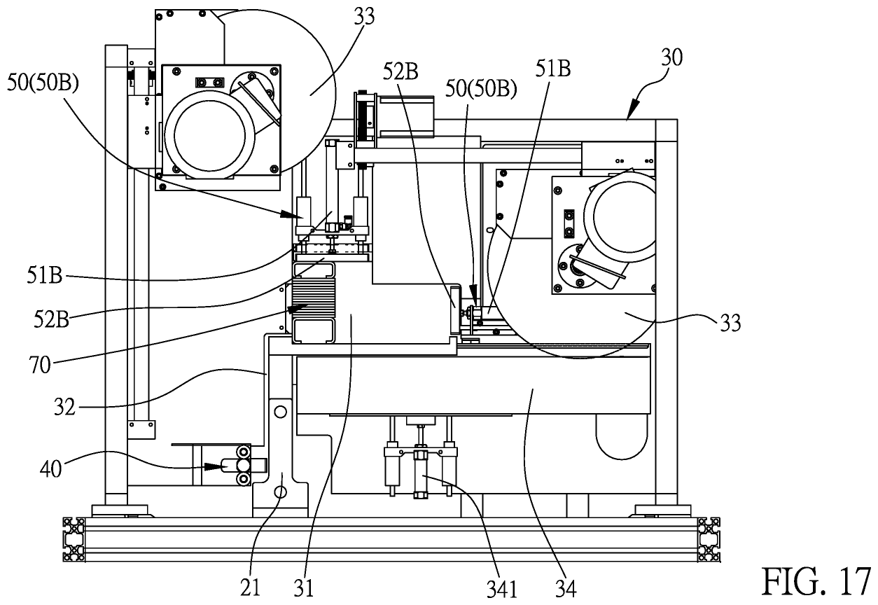

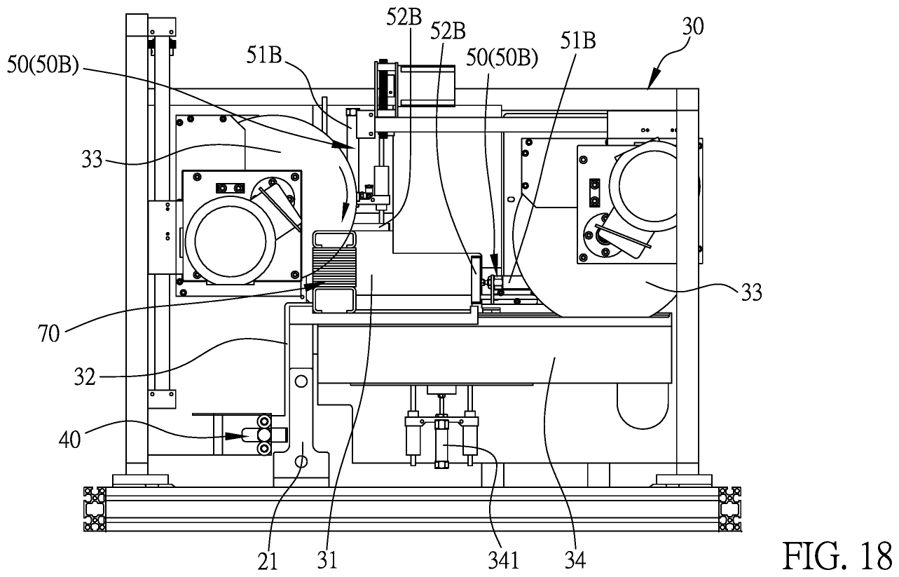

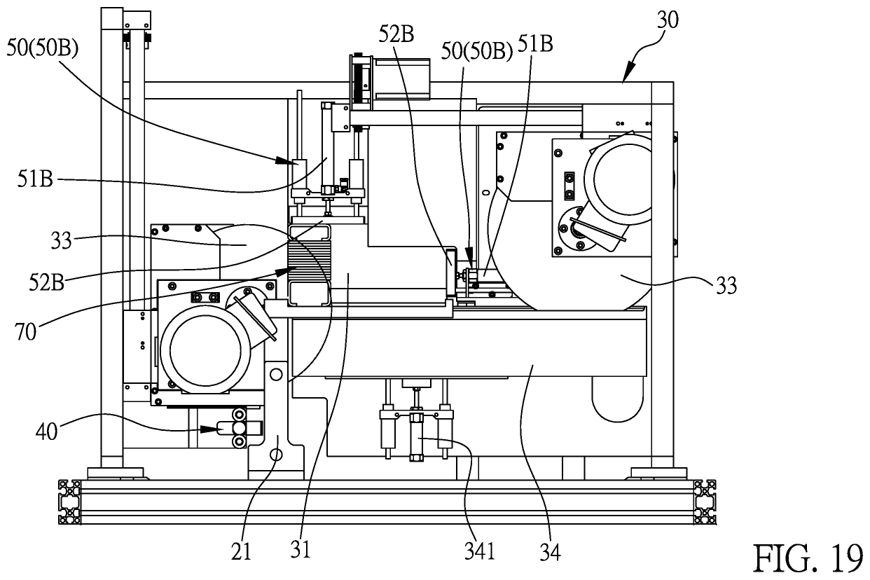

Referring to FIGS. 8-13, as cutting the workpiece (i.e., a curtain 70), the curtain 70 is placed on the accommodation groove 212 of the top part of the at least one support set 21 and is parallel to the base 10 so that the cutting device 30 pushes the curtain 70 to the movable positioning device 60 along the base 10 based on a desired cutting length, and the fixing sheet 62 of the movable positioning device 60 is driven by the fifth moving mechanism 61 to move along the base 10 so that the curtain 70 is positioned on the base 10, and the two press elements 52A of the first clamping part 50A are respectively actuated by the two third moving mechanisms 51A to vertically move along the base 10 so as to clamp the curtain 70. Thereafter, the holding plate 34 of the cutting device 30 is driven by the first moving mechanism 341 to descend so that the cutting device 60 moves to a predetermined cut position along the two slide rails 11 based on the desired cutting length of the curtain 70, wherein an end of the curtain 70 moves through the first space 31 of the cutting device 30, and the second moving mechanism 41 of the displacement device 40 actuates the actuation seat 42 to move along the base 10, wherein the movable drive rod 43 of the actuation seat 42 inserts into the at least one orifice 211 of the at least one support set 21 so as to move the support sets 21 extending out of the second space 32 toward the holder 44, such that the two springs 45 on the holder 44 are pressed, and the holding plate 34 of the cutting device 30 is driven by the first moving mechanism 341 so as to lift and to support the curtain 70. As shown in FIG. 14-16 or 17-19, the fourth moving mechanism 51B of one of the two second clamping parts 50B actuates the abutting plate 52B to movably abut against the curtain 70, and one of the two cutters 33 of the cutting device 30 moves along an axial track (i.e., a datum line) around the base 10 so as to cut the end of the curtain 70 over the datum line. After cutting the end of the curtain 70, the cutting device 30 moves toward a predetermined position of the other end of the curtain 70 along the base 10 so that the fourth moving mechanism 51B of the one second clamping part 50B actuates the abutting plate 52B to movably abut against the curtain 70, the one cutter 33 of the cutting device 30 moves along the axial track of the base 10 so as to cut the other end of the curtain 70, and the other end of the curtain 70 over the datum line of the base 10 is cut, thus cutting the curtain 70.

Thereby, the automatic curtain cutting machine contains advantages as follows:

1. The automatic curtain cutting machine cuts the two ends of the curtain 70 automatically and accurately so as to avoid turning the curtain 70, thus cutting the curtain 70 quickly and easily.

2. The two ends of the curtain 70 are cut by way of the cutting device 30 moving on the base 10, such that only the cutting device 30 is required so as to simplify the automatic curtain cutting machine and to reduce fabrication cost.

While various embodiments in accordance with the present invention have been shown and described, it is clear to those skilled in the art that further embodiments may be made without departing from the scope of the present invention.

What is claimed is:

1. An automatic curtain cutting machine comprising:
a base axially extending and configured to parallelly hold a curtain on the base, the curtain moving on the base;
a support unit including multiple support sets movably arranged on the base, and the support unit configured to support the curtain;
a cutting device mounted and moving on the base, and the cutting device including a first space, a second space, and at least one cutter;
the first space configured to pass through the curtain and connecting with the second space so that each of the multiple support sets moves through the second space, and the at least one cutter being fixed outside the first space and vertically moving along a track of the curtain, wherein the track is a datum line so that an end of the curtain over the datum line is cut;
a displacement device disposed on the cutting device and moving with the cutting device, and the displacement device configured to move the multiple support sets which correspond to a moving track of the at least one cutter; and
at least one clamp device configured to clamp the curtain so that the curtain is cut.

2. The automatic curtain cutting machine as claimed in claim 1, wherein the base is elongated, and the base includes two slide rails arranged between two ends of the base respectively.

3. The automatic curtain cutting machine as claimed in claim 1, wherein each of the multiple support sets has at least one orifice defined proximate to a bottom of each support set, at least one part of the multiple support sets is in an inverted L shape and has an accommodation groove defined on a top part of the at least one support set.

4. The automatic curtain cutting machine as claimed in claim 1, wherein the cutting device is mounted and moves on two slide rails of the base.

5. The automatic curtain cutting machine as claimed in claim 1, wherein a bottom of the first space of the cutting device flushes with a top of each support set of the support unit.

6. The automatic curtain cutting machine as claimed in claim 1, wherein the cutting device further includes a holding plate arranged below the first space, and the holding plate has a first moving mechanism formed on a bottom thereof so as to actuate the holding plate to lift and descend, wherein when the holding plate is actuated by the first moving mechanism to lift, a top of the holding plate flushes with the accommodation groove of the at least one support set.

7. The automatic curtain cutting machine as claimed in claim 1, wherein the displacement device includes a second moving mechanism, an actuation seat driven by the second moving mechanism so as to move along the base, a movable drive rod secured on the actuation seat, a holder configured to hold the multiple support sets, and at least one spring configured to push the multiple support sets to move back toward original positions respectively.

8. The automatic curtain cutting machine as claimed in claim 1, wherein the at least one clamp device includes a first clamping part and at least one second clamping part, the first clamping part is fixed on one of the multiple support sets of the support unit, the first clamping part has two third moving mechanisms and two press elements driven by the two third moving mechanism to vertically move along the base, the two second clamping parts are arranged beside the first space of the cutting device so as to move, when the cutting device moves, wherein each of the two second clamping parts has a fourth moving mechanism and an abutting plate driven by the fourth moving mechanism so as to move close to or away from the first space.

9. The automatic curtain cutting machine as claimed in claim 1, wherein the cutting device further includes a third space so that when the cutting device slides, the cutting device slides avoids moving through the first clamping part by way of the third space.

10. The automatic curtain cutting machine as claimed in claim 1 further comprising a movable positioning device mounted on an end of the base, wherein the movable positioning device includes a fifth moving mechanism and a fixing sheet actuated by the fifth moving mechanism so as to move on the base.
